(19) United States
(12) Patent Application Publication
(10) Pub. No.: US 2017/0024748 A1
(43) Pub. Date: Jan. 26, 2017

(54) GUIDED DISCUSSION PLATFORM FOR MULTIPLE PARTIES

(71) Applicant: Patient Doctor Technologies, Inc., Sunnyvale, CA (US)

(72) Inventor: Amer Haider, Saratoga, CA (US)

(73) Assignee: Patient Doctor Technologies, Inc., Sunnyvale, CA (US)

(21) Appl. No.: 14/805,738

(22) Filed: Jul. 22, 2015

(51) Int. Cl. G06Q 30/02

(52) U.S. Cl. CPC G06Q 30/0201

(57) ABSTRACT

An example method for facilitating a discussion session between two devices includes acquiring a checklist from a first provider. A set of questions and answers is determined from the checklist, where each question is associated with respective answer(s). The method includes acquiring another checklist and selecting a process associated with the checklist based, at least in part, on a selection from a first device. The method includes providing a question of the set to the first device and providing answer(s) of the first set to the second device, the answer(s) being associated with the first question. The method includes receiving a selected answer from the second device, where the selected answer is associated with the question. The method includes determining another question from the set and associated answer(s) based, at least in part, on the question and the selected answer.

### PRIORITY

The present application claims priority from a U.S. Provisional patent application Ser. No. 62/029,527, titled “Systems and Methods for providing a guided discussion platform” and filed on Jul. 27, 2014, which is also hereby incorporated by reference.

### FIELD OF THE INVENTION

The present disclosure generally relates to systems and methods for providing a guided discussion platform, including, but not limited to, a discussion session between two computing devices.

### BACKGROUND

Consumers and businesses pay a lot of money to obtain consultation services from professionals in the areas of medicine, customer service, support, law, financials, and other fields. These consultation services typically involve discussions between a professional who has domain expertise and/or is licensed to give advice on a specific topic, and a consumer or a business, who is seeking advice or opinion.

The process of getting advice or consultation begins with a stage of initial information exchange between the parties. These initial information exchanges typically involve an in-person and/or telephonic interview or discussion between the parties. The quality and effectiveness of verbal discussions at this critical initial stage can greatly impact the outcome and direction of advice and subsequent strategy and action plan. To help improve the quality and focus of these discussions, during the interview and/or discussion, many firms will use a list of items, such as a checklist or process, to make sure that key points and topics are discussed and addressed. The checklist helps the service provider estimate the cost of the subsequent actions. Typically, the cost or rate of professionals varies based upon their training, past successes, recognized process and peer recommendations. The rate between different professional and consulting firms can vary significantly in the same field of practice.

Clients face hurdles using the current environment. There is no way to determine if the proposed advice is the best advice available, or if the advice even adequately addresses the client's needs. There is no simple way to know what options another consultant will provide without going through the arduous process of hiring a new consultant. Further, one cannot gather data from others who have gone through a similar situation except for relying on the experience of the consultant. The client does not know if a consultant is correct or what other consultants will advise for the same situation.

Most clients choose a consultant based on reputation or word of mouth. Alternatively, a client may rely on reviews, which are not accurate. Thus, the client does not know if the consultant is providing the best solution for the situation. Many consultants will not take difficult cases or deal with troublesome clients in order to protect their reputations and garnish positive reviews. A client also faces the dilemma when hiring an expensive firm that the results and quality are based on the individual consultant assigned to the client. In these instances, who the client gets is the luck of the draw. Further, a huge variance exists in the quality and type of advice that a client receives based on the consultant assigned.

Consultants, or experts, also may face problems with the current environment. A consultant must determine whether the client provided all the relevant information for their situation, or did the client leave something out. This situation is especially prevalent when a client does not want to disclose embarrassing or damaging information. Consultants also want to provide the best advice but only can draw upon their experience. A consultant's experience and access to a network of colleagues and partners in the firm will determine the appropriate fees or prices, as well as any earned reputation.

### SUMMARY

The disclosed embodiments provide tools to address the problems discussed above by offering a unique technology couple with unique processes.

Consultants and clients suffer from a huge difference in knowledge disparity. This difference poses a problem because the client may be intimidated by disparity. As a result, the client may not speak up and discuss information that is relevant, which may result in a psychological barrier. This may be especially true in medical settings or with clients who do not want to second guess a consultant for fear of getting lower quality advice from an agitated consultant.

Current consultation methods do not use any technology tools that can inform the participants in a consultation in realtime about decisions and their potential impact. Additionally, current consultation systems do not use any realtime tools to help and inform a verbal discussion as it occurs. For example, when one meets with a lawyer, there may be a lot of exchange of digital documents but the advice and discussion during the consultation does not include any intelligent digital tools that are shared by the consultant and the client.

One reason why consultants and clients do not use intelligent digital tools during a consultation may be nothing is available to provide value to the consultation. Thus, the disclosed embodiments combine a human interaction and experience with computer intelligence while fitting the technology into a realtime discussion between a client and a consultant.

Digital synchronous and asynchronous discussion platforms may provide benefits when used in various professional settings. These discussion platforms enable a rich, multimedia conversation between consultation professionals, service providers and their customers, namely consumers, individuals and businesses. The discussion platforms may provide many benefits of convenience, costs and efficiency, with features like remote participation, video, audio, chat, security, privacy, transcription, simultaneous presentations, and virtual reality avatars and augmentation. However, these discussion platforms are not typically used between a client and a professional during the consultations described above.

A method is described for facilitating a discussion session between two devices includes acquiring a checklist from a first provider. A set of questions and answers is determined from the checklist, where each question is associated with respective answer(s). The method includes acquiring another checklist and selecting a process associated with the checklist based, at least in part, on a selection from a first user. The method includes providing a question of the set to the first user and providing answer(s) of the first set to the second user, the answer(s) being associated with the first question. The method includes receiving a selected answer from the second user, where the selected answer is associated with the question. The method includes determining another question from the set and associated answer(s) based, at least in part, on the question and the selected answer.

The disclosed embodiments differ from an automated computer assisted test or question and answer process because the realtime involvement of the consultant, who is assisted by an electronic device.

### BRIEF DESCRIPTION OF THE FIGURES

The accompanying Figures, which are incorporated herein and form part of the specification, illustrate the present invention and, together with the description, further serve to explain the principles of the invention and to enable a person skilled in the relevant art(s) to make and use the invention.

FIG. 1A is a block diagram of a guided discussion platform system in which an embodiment of the present invention may be implemented.

FIG. 1B is a block diagram illustrating an example discussion server, according to some embodiments.

FIG. 1C illustrates example data structures used by the discussion server, according to some embodiments.

FIG. 2 depicts a flowchart of general operation of a discussion server, according to some embodiments.

FIG. 3 depicts a flowchart of a method for facilitating a discussion session between two computing devices, according to some embodiments.

FIGS. 4A and 4B depict flowcharts of operation of two computing devices during a discussion session, according to some embodiments.

FIG. 5 illustrates two examples of discussion sessions showing questions and answers that are provided to the two computing devices, according to some embodiments.

FIGS. 6A and 6B are example decision trees that are used by the logic of a discussion server when facilitating a discussion session.

FIG. 7 is a block diagram of an example computer system in which embodiments of the present invention may be implemented.

FIG. 8 depicts a flowchart of a method for facilitating a discussion session between two computing devices, according to some embodiments.

FIG. 9 depicts a flowchart for generating the next steps in a discussion session, according to some embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The disclosure described herein illustrates systems, methods, and computer-readable media that allow parties engaged in a professional consultation service (referred to as a discussion session) to use a digital discussion platform that incorporates questions and possible answers that direct the consultation. The disclosure also provides the parties the ability to choose a mutually agreed measure of quality and effectiveness of the consultations. The disclosure also describes how the logic that determines the questions and answers can be modified to improve the quality and effectiveness of the consultation between the two parties. The consultation between the parties is directed by providing questions to one party and a set of possible answers to the other party. Based on the actual question and answer used, the system determines a next set of question and associated answers to provide to both parties. The system can be used to facilitate discussion sessions for a variety of reasons. One benefit is to speed up consultations between two parties having an attorney-client, a doctor-patient, or a similar relationship. By providing means for a more efficient and focused consultation, a determination of a final procedure to be performed, such as a surgery, can be obtained in a faster and more efficient manner than before. For example, the doctor would only need 10 minutes of consultation with a patient as opposed to one hour. Another benefit is workload distribution. The patient would be forced to prepare and do homework on the provider of professional services as well as own issues.

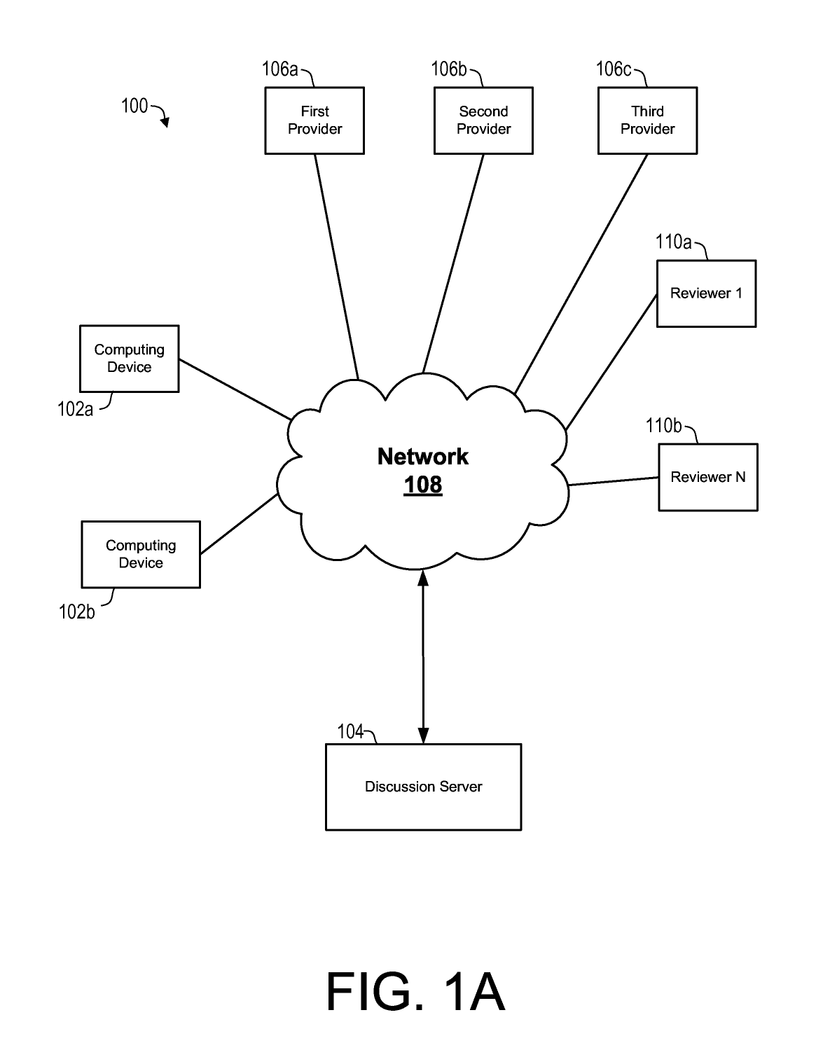

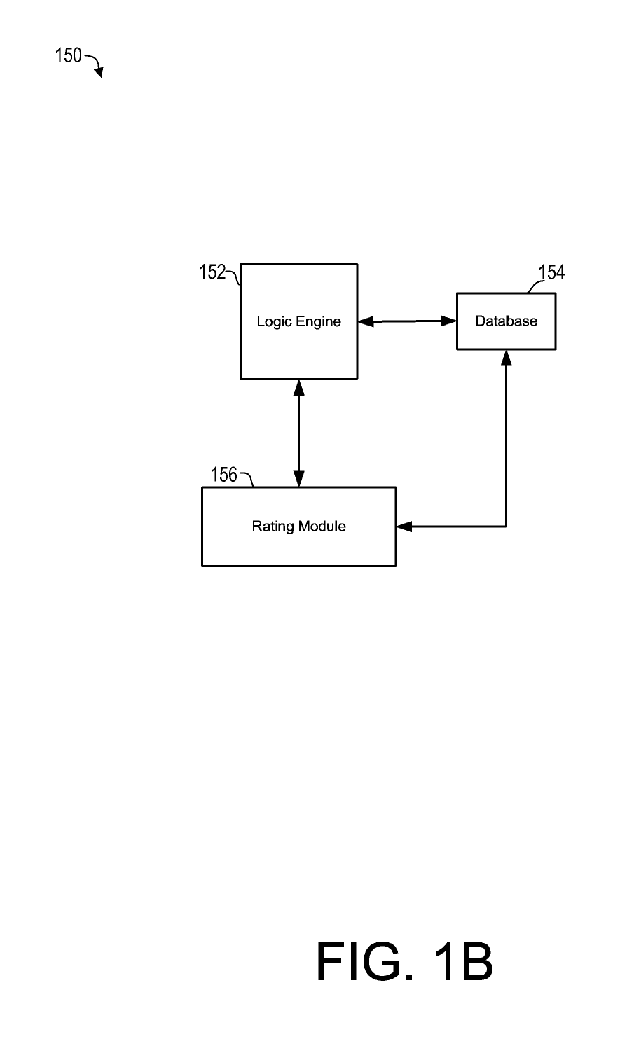

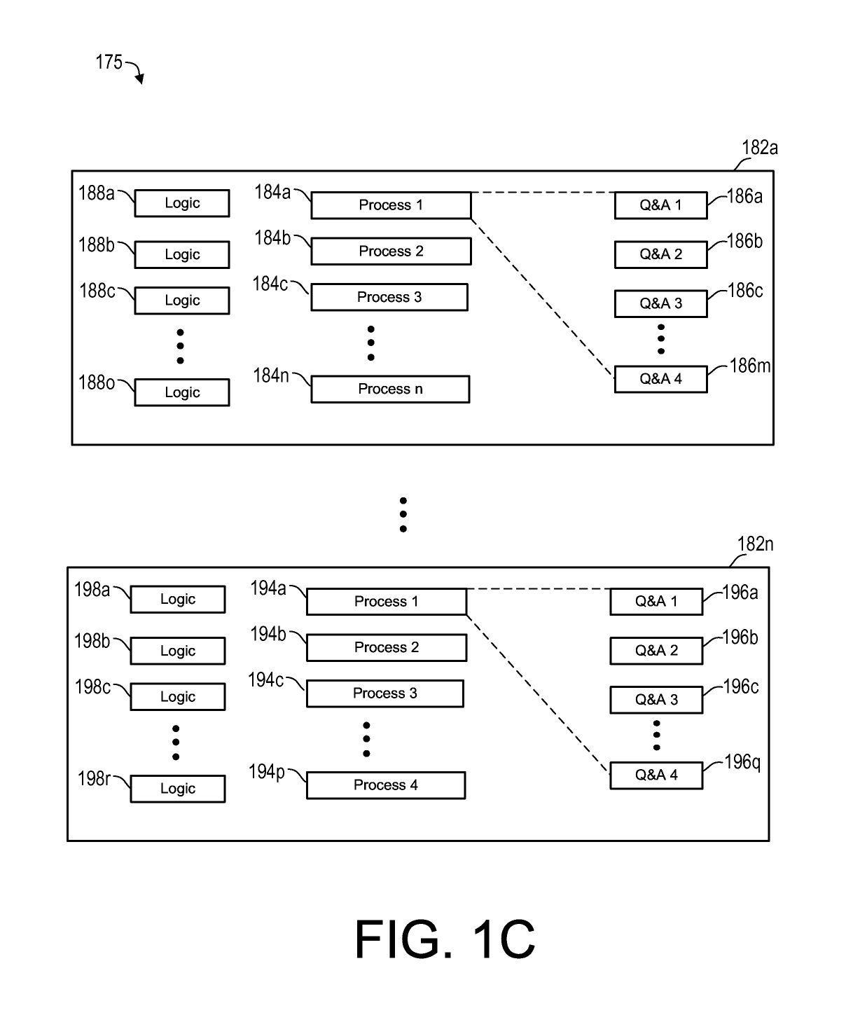

The system and methods described herein facilitates discussion between computing devices. FIG. 1 illustrates an example system 100 of such a guided discussion platform among computing devices 102a and 102b as provided by a discussion server 104. Each of the computing devices 102a and 102b can be implemented using any one of a personal computer, a mobile phone, a smart phone, a tablet, a smart device, etc. In one embodiment, each of the computing devices 102a and 102b can be implemented using a memory storing a program (operable to perform parts of the functionality described herein) and a processing unit (e.g., a processor, FPGA, etc.) operable to execute that program. The discussion server 104 can similarly be implemented using a personal computer, a mobile phone, a smart phone, a tablet, a smart device, etc., in addition to being implemented using a router, a bridge, or a server. In one embodiment, the discussion server can be implemented using a memory storing a program (operable to perform parts of the functionality described herein) and a processing unit (e.g., a processor, FPGA, etc.) operable to execute that program. In one embodiment, parts of the functionality of the discussion server 104 are distributed among multiple computing devices that communicate with each other over a network 108. The network 108 can be implemented using one or more of a Local Area Network, a Wide Area Network, a wireless network, a cellular network, and/or the Internet.

The discussion server 104 provides questions and answers to the computing devices 102a and 102b (referred to collectively as computing devices 102). For example, the discussion server 104 can provide a question to the computing device 102a, and a corresponding one or more answers to the computing device 102b. The provided answer(s) are possible answers to the question. Thus, the computing devices 102 participate in a discussion session, which includes multiple rounds of a question being posed by device 102a, and computing device 102b providing an answer to that question. During each round, the question and answer are typically different from the questions and answers used in the preceding round or the succeeding round.

During the discussion session, the computing device 102a can pose a question to device 102b. The question can be posed in a variety of ways, including by the computing device 102a transmitting data indicating the question to the computing device 102b. In one embodiment, a user of the computing device 102a (e.g., a doctor) can ask a question of a user of the computing device 102b (e.g., a patient), such as a question relating to the health of the patient. It is noted that the patient—doctor relationship between the users of the computing devices 102 is exemplary only, and the users can have a client—attorney (or another type of relationship that involves the next steps), and thus questions and answers, and thus the discussion session, will relate to another topic (called a topic herein for simplicity). A user may be defined as an individual, a group, an entity, an automated device, an electronic medical record (EMR), an enterprise resource planning device (ERP) and the like.

Computing device 102b can then select, by receiving an input to the computing device 102b or by accessing stored parameters indicating the health of the patient, an answer to the received question. The answer also may be selected from the answers received from the discussion server 104. The answer is then sent back from the computing device 102b to the discussion server 104. Upon receiving the answer, the discussion server 104 then selects a next question and associated information that are sent back to the computing devices 102a and 102b.

It is also noted that in one embodiment, the discussion server 104 can switch which computing device is provided the questions and which one is provided the answers during the discussion session, referred to as switching sides. In other words, the computing device 102b can provide a question to device 102a, and the computing device 102a can provide an answer to a computing device 102b. A user of the computing device 102a can ask a question to the user of the computing device 102b relating to the professional qualifications of the user of the computing device 102b. In this case, the succeeding questions selected for the computing device 102a and answers selected for the computing device 102b are determined by the discussion server 104 based on the question and answer selected during the discussion session. Various embodiments of the system architecture and methods of operation are described below.

The discussion server 104 first generates sets of next steps, as well as associated logic for selecting a certain question and associated answers to the devices 102. One or more providers 106a-106c can send information to the discussion server 104 via a network 108. The information can include next steps associated with a particular topic in a particular area. For example, the information can refer to a certain medical process (e.g., an arthroscopic knee surgery). Each provider can offer information relating to a different set of questions and answers for that process. The discussion server 104 then can generate logic and associated steps for each of the topics. The steps can be separated based on the provider as well.

During the discussion session, the discussion server 104 can rate the discussion session (referred to as a session rating). Furthermore, one or more reviewers 110a-110b can also provide ratings of the discussion session (referred to as review ratings). Based on a combined rating (which includes the session rating and/or the review ratings), the logic and next steps can be updated. Some embodiments of the logic generation, as well as of the storage and update of the next steps are described below.

The session rating can be based on a variety of factors, such as a length of the discussion session, the number of questions asked during the discussion session, the accuracy of the answers (i.e., as compared to the percentages the provided answers are used by other users when answering the same or related questions for the same or related process). The discussion server can assign different weights to each of these factors when determining the session rating. Also, the discussion server can give a rating to each question and answer used during the discussion session. If a certain question is not used in a given number (e.g., a certain threshold number) of discussion sessions (e.g., a 1,000 discussion sessions), then that question may not be provided by the discussion server during subsequent discussion sessions for the same or similar process. The discussion server can also optionally check any characteristics of the users (e.g., such as a medical history of the patient) to further classify the questions and answers. The logic associated with that process would be appropriately updated to reflect that certain questions and answers are not used.

The review rating can be received from multiple reviewers and/or the users of the discussion session itself. For example, after a discussion session, the two users (e.g., the doctor and the patient) can each provide a rating of the overall discussion session, and, optionally, of each set of questions and answers. Furthermore, the two users can provide follow-up review ratings that indicate the accuracy of the discussion session, such as whether a diagnosis or a recommendation obtained during the discussion session is useful (e.g., whether a certain knee operation is helpful to the patient). The other reviewers can also rate the accuracy and/or popularity of the questions and answers, and optionally of the logic, for each process. It is noted that the next steps and the logic would need to be made public to the reviewers by the discussion server, such as by publishing the next steps and/or the logic on a web page, or by other means. The discussion server can assign different weights to the session rating and to the review rating when determining the combined rating, e.g., each is worth 50%.

FIG. 1B illustrates some embodiments of a discussion server 150 (e.g., as an example of discussion server 104). The discussion server 150 includes a logic engine 152, a database 154, and a rating module 156. The logic engine 152 receives the information from the providers that includes questions and answers for a certain process, and generates logic associated with these questions and answers. The database 154 stores the Q&A and the associated logic for each process and each provider, such as in a manner illustrated by FIG. 1C. The database 154 can also store the ratings for each process, including session ratings, review ratings, and/or combined ratings. The rating module 156 generates session ratings for each discussion session, receives reviews and/or ratings from reviewers, and generates (or updates) a combined rating for each process. The logic engine 152 can update the logic and/or the Q&A for a certain process based on the rating (whether a new rating or an updated rating) for that process.

FIG. 1C illustrates some embodiments of how data 175 is stored by a database of a discussion server. The data 175 can include data related to various processes as received from various providers. For example, the discussion server can receive checklists from each provider. Each checklist is associated with some process. The discussion server then generates the questions and answers and logic from each such checklist. For example, the questions and answers generated by the discussion server can be populated using a questionnaire that is often contained by the checklist. The associated logic indicates how which of these questions and answers should be used, and in what order. As the logic is modified by the discussion server, e.g., after conducting multiple discussion sessions for the associated process, the questions and answers and/or the logic can be modified. Furthermore, as described herein, during a discussion session, a question that is selected depends on the previous questions and answers that are received.

The data 175 can be organized and/or cross referenced according to types of processes, areas of processes, and/or based on the providers. For example, the data 175 can be indexed based on an area of processes (such as legal processes, medical processes, real-estate processes). The data 175 can be indexed based on a provider within each process area, such as within the medical procedure area, indexed based on a MAYO CLINIC™ provider, a JOHN HOPKINS™ provider, a MASSACHUSETS GENERAL HOSPITAL™ provider, etc. Furthermore, the processes from each provider can be further indexed based on the type of the process itself. Thus, the processes from JOHN HOPKINS™ can be further indexed based on a type of the process, such as arthroscopic surgeries, a type of ailment, etc. It is noted that the embodiments described below are illustrative only, and other approaches can be used.

In FIG. 1C, data from a first provider is shown in a first set 182a. Various techniques can be used to associate different data together, such as by using objects, links, references, etc. The first set 182a can correspond to data for processes 184a-184n that is received from a first provider. The first set 182 also includes logic 188a-188o, where each logic is associated with each process. The logic, e.g., logic 188a, determines which of the questions and answers (e.g., 186a-186m) will be provided to the two computing devices. The logic engine generates the questions and answers for each process based on the information. For example, process 1 184a is associated with questions and answers 186a-186m. Logic 188a is associated with the process 184a. FIG. 1C also shows data from different providers, as shown by the nth set 182n. The nth set 182n similarly stores data for multiple processes 194a-194p. Similarly, process 194a includes Q&A 196a-196q. Each one of logic 198a-198r selects the Q&A for a respective process 194.

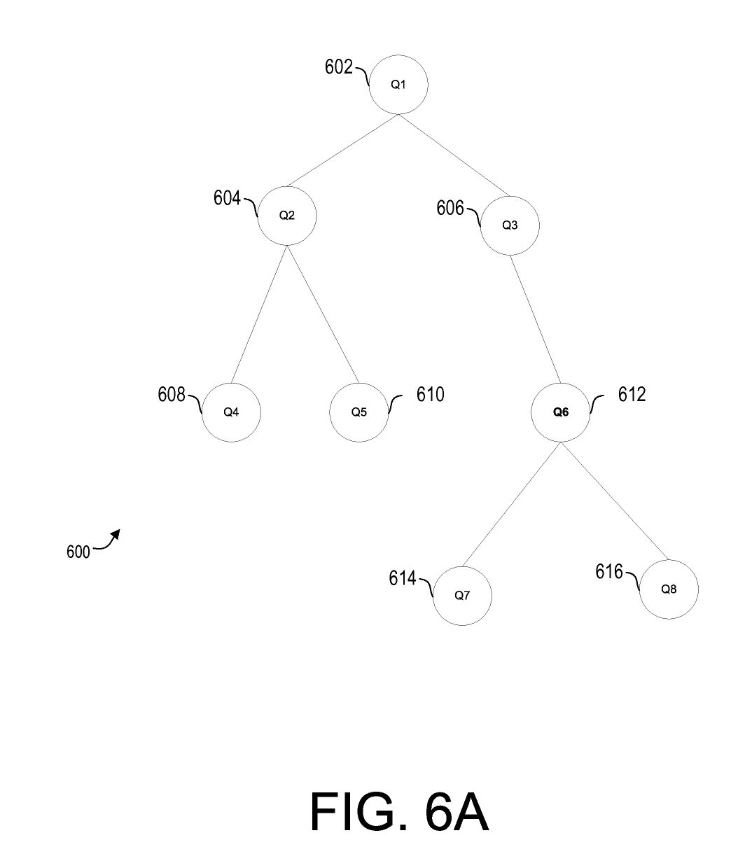

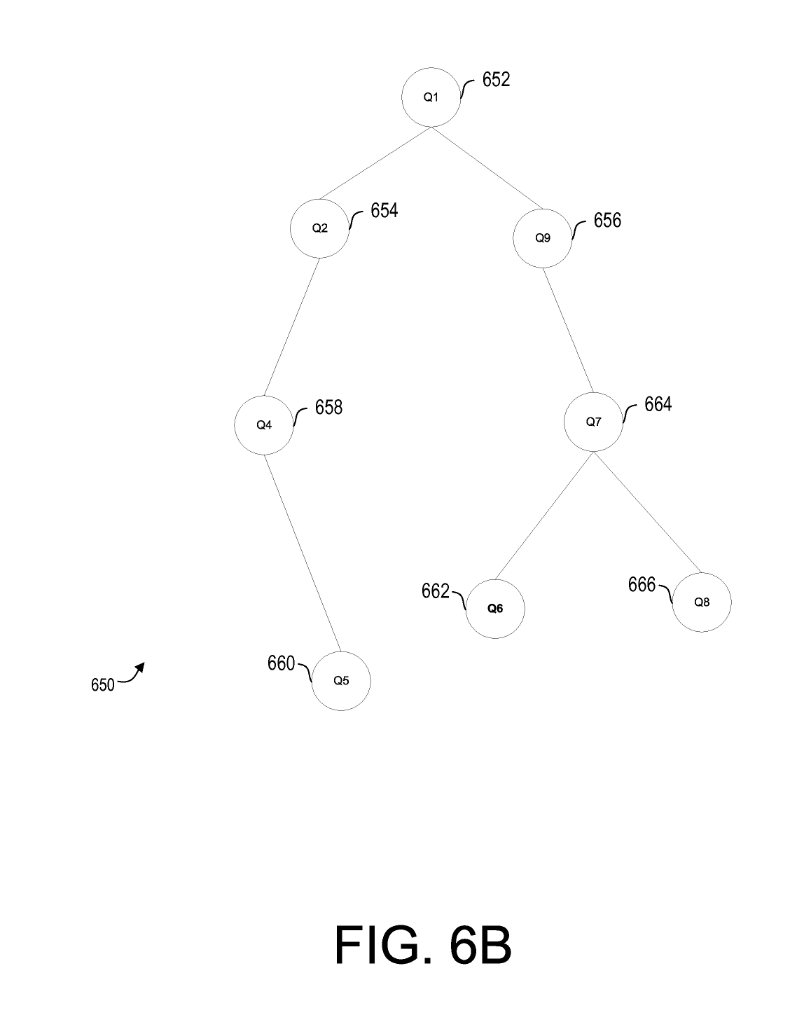

The logic 188a determines which question and answers of the Q&A 186a-186m is selected next (i.e., for provision to the computing devices). The logic 188a can select any one of the Q&A sets 186a-186m, depending on the answers selected for the previous question. The logic 188a can select some of the questions of the Q&A 186 to be provided to a first computing device and the corresponding answers to a second computing device. One embodiment of the logic used to select the next Q&A is shown with reference to FIG. 6A. The logic 188a can be updated, such as shown by FIG. 6B. In other embodiments, other techniques and conditions used to implement the logic 188a-188o can be used, such as by using expert systems, knowledge systems, decision trees (e.g., binary trees), and/or other decision making techniques. Logic 188a can be modified based on the ratings. For example, before a modification, after providing Q&A 186a, the logic 188a would select Q&A 186b. However, after the modification, the logic 188a instead would select Q&A 186c after providing Q&A 188a. The logic 188a can also facilitate switching sides for at least one question & answer, i.e., select at least one of the questions of the Q&A 186 to be provided to the second computing device and the associated answers to the first computing device.

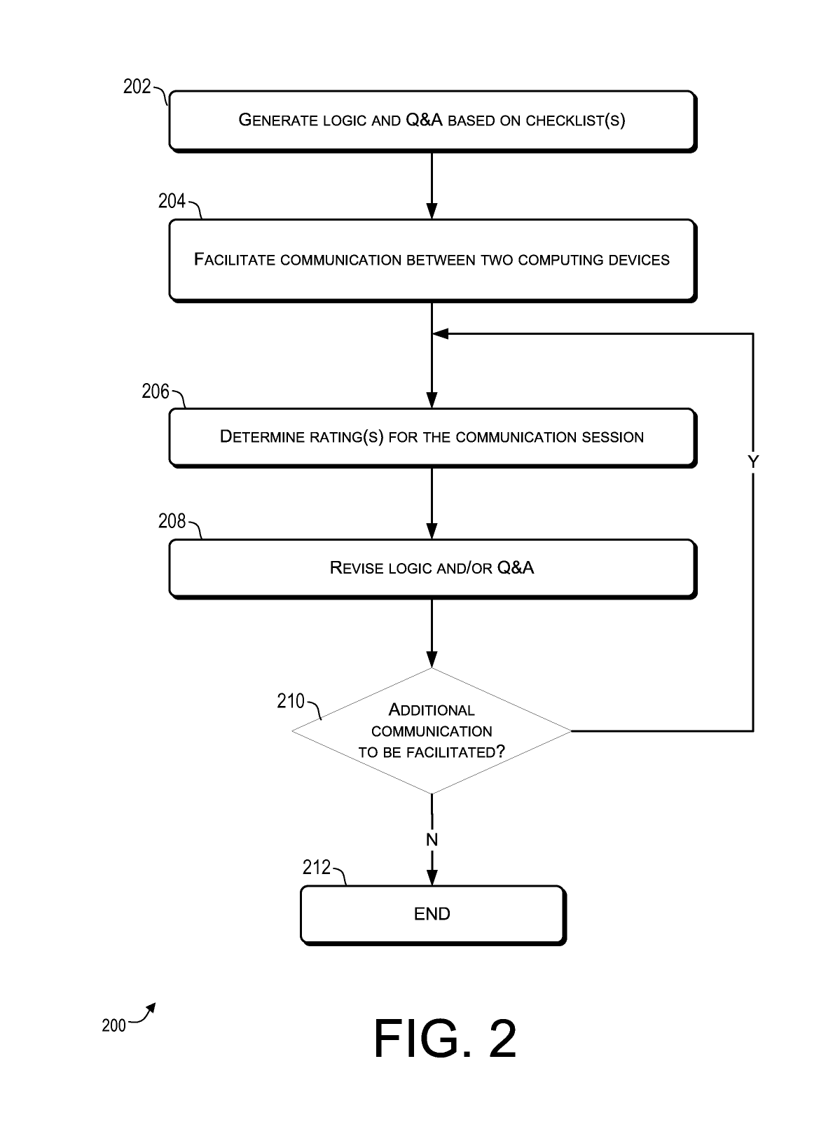

FIG. 2 illustrates a process 200 of operation of the discussion server, according to some embodiments. The method of FIG. 2 will be described in reference to elements of FIGS. 1A-1C. However, it is noted that the method is not limited to that implementation. Also, the method of process 200 may be modified by those skilled in the art in order to derive alternative embodiment(s). Also, the steps may occur in a different order than shown, some steps may be performed concurrently, some steps may be combined with other steps, and/or some steps may be absent, as desired.

At element 202, the discussion server generates logic and the next steps for a process based, at least in part, on a checklist. The discussion server can access stored checklists and/or receive checklists from provider(s) and/or other entities. The discussion server can generate a new logic or update an existing logic. Similarly, the discussion server can generate new next steps or update existing next steps. The element 202 is typically performed for multiple checklists, such as to generate the multiple data sets of FIG. 1C.

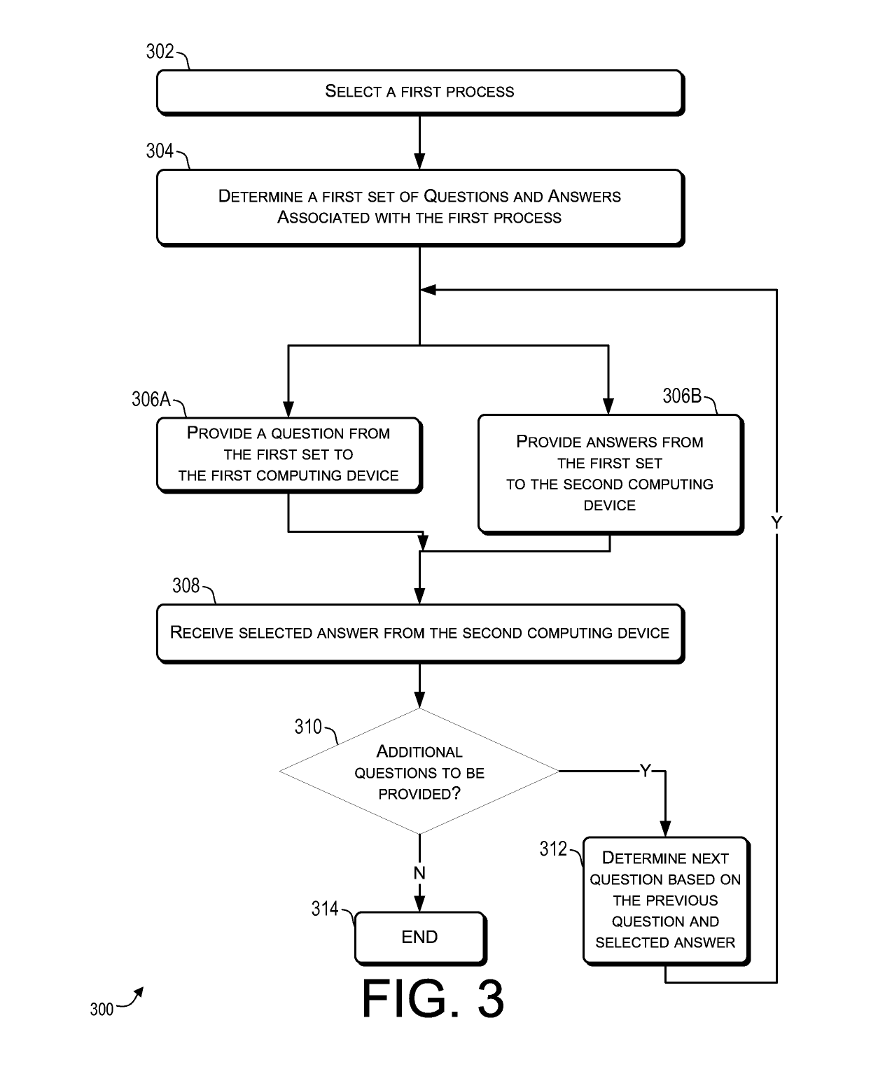

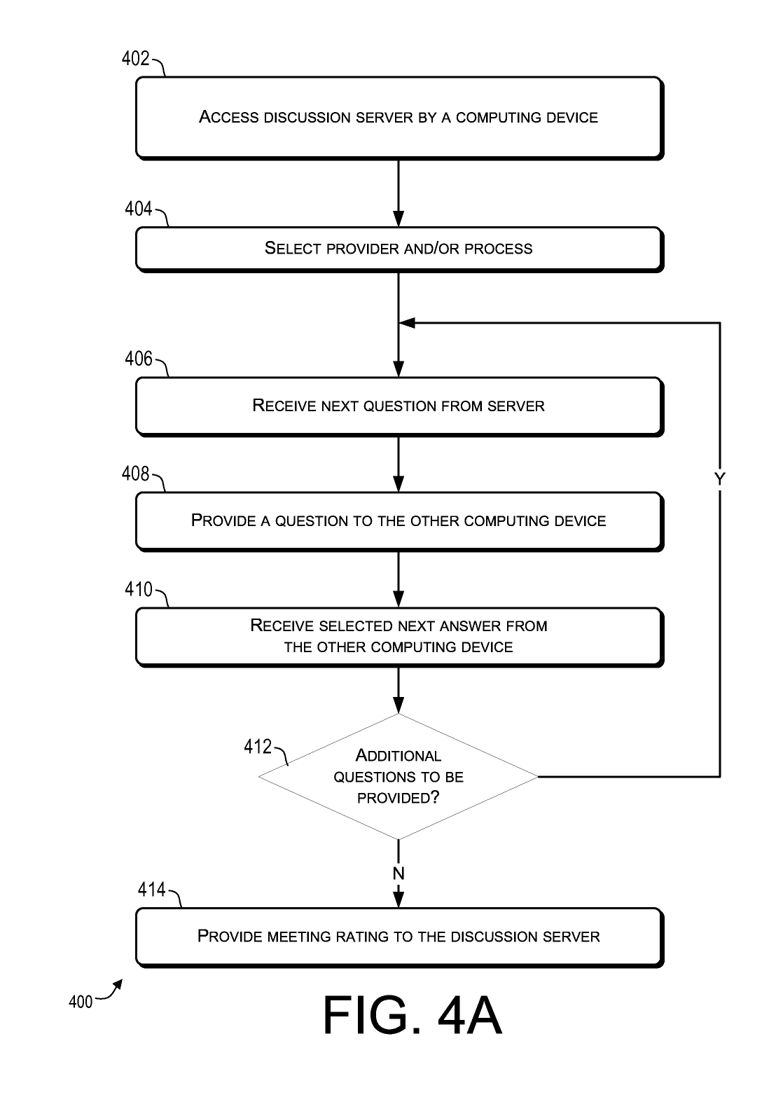

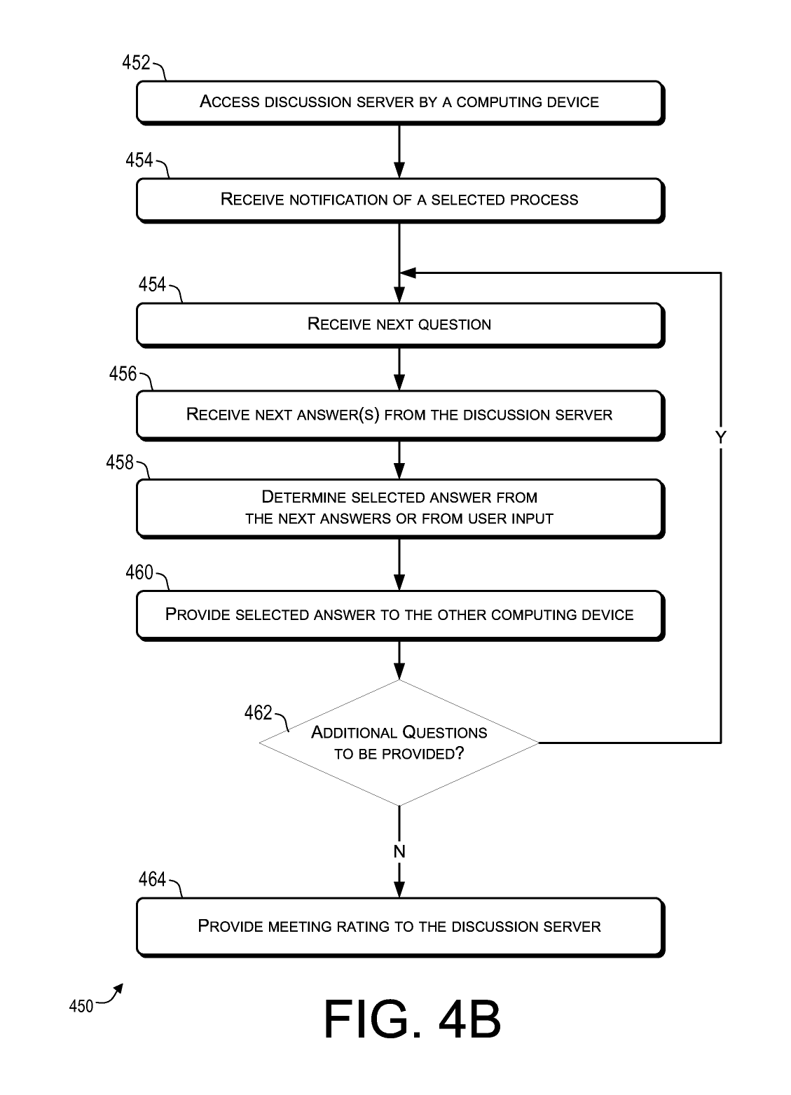

At element 204, the discussion server facilitates discussion between two computing devices during a discussion session. The client input and the expert input may be from the computing devices. The discussion server can transmit a question to a first computing device and a set of answers corresponding to that question to the second computing device. The discussion server then selects the next question and associated answers for transmission to the computing devices. Some embodiments of the operation of the discussion server when selecting and providing the Q&A are described below with reference to FIG. 3. Some embodiments of the operation of the computing devices when receiving Q&A from the discussion server are described below with reference to FIGS. 4A and 4B.

At element 206, the discussion server determines ratings for the discussion of element 204. The discussion server determines session ratings for the discussion session based on a variety of factors. The discussion server can also determine review ratings based on ratings that are received from reviewers, and then generate a combined rating based on the session rating and the review rating.

At element 208, the discussion server revises the logic and/or the checklists (i.e., the Q&A for each of the processes) based on the ratings and/or additional information received from the providers. At element 210, the discussion server determines whether there is additional discussion to be facilitated between the two computing devices in the same discussion session (i.e., in the discussion session of element 204). If there is an additional discussion to be facilitated, element 206 is performed again. Otherwise, the method of FIG. 2 ends.

FIG. 3 illustrates a topic 300 of operation of the discussion server when facilitating discussion between two computing devices during a discussion session, according to some embodiments. The method of FIG. 3 will be described in reference to elements of FIGS. 1A-1C. However, it is noted that the method is not limited to that implementation. Also, the method of topic 300 may be modified by those skilled in the art in order to derive alternative embodiment(s). Also, the steps may occur in a different order than shown, some steps may be performed concurrently, some steps may be combined with other steps, and/or some steps may be absent, as desired.

At element 302, the discussion server selects a first topic, such as based on a selection received from one of the two computing devices. The discussion server also selects the logic and the next steps that are associated with the selected topic. For example, the discussion server can receive the topic selection from a computing device of a patient in the medical area, or from a client in the legal area.

At element 304, the discussion server determines a first set of steps associated with first topic to provide to the computing devices. The logic associated with the selected topic can determine the first set of steps, and optionally based on parameters of the users of the two computing devices. For example, if the selected topic is directed to the medical arts, and particularly to a knee surgery, the logic can determine the first steps to be provided (e.g., selected from the selected topic) based on some physical characteristics of the patient (i.e., the user of the second computing device).

At elements 306A and 306B, the selected question and answers are provided to the first and second computing devices, respectively. The discussion server can provide the selected the next steps to the computing devices using any one of a variety of techniques, such as by sending messages, via a network, to the respective computing devices. At element 308, the discussion server receives a selected answer from the second computing device. It is noted that the selected answer can be one of the answers provided to the second computing device (at element 306B), or the selected answer can be another answer, such as selected by a user of the second computing device. If the selected answer is different from the provided answers, then the logic and/or the selection of the next Q&A set may be affected.

At element 310, the discussion server determines whether there are additional next steps to be provided to the computing devices. This determination can be based on input from either one of the computing devices (e.g., indicating that the current discussion session should be terminated), or if there are no more next steps associated with the current topic. If there are additional steps to be provided, topic 300 moves to element 312. Otherwise, the method of FIG. 3 ends at element 314.

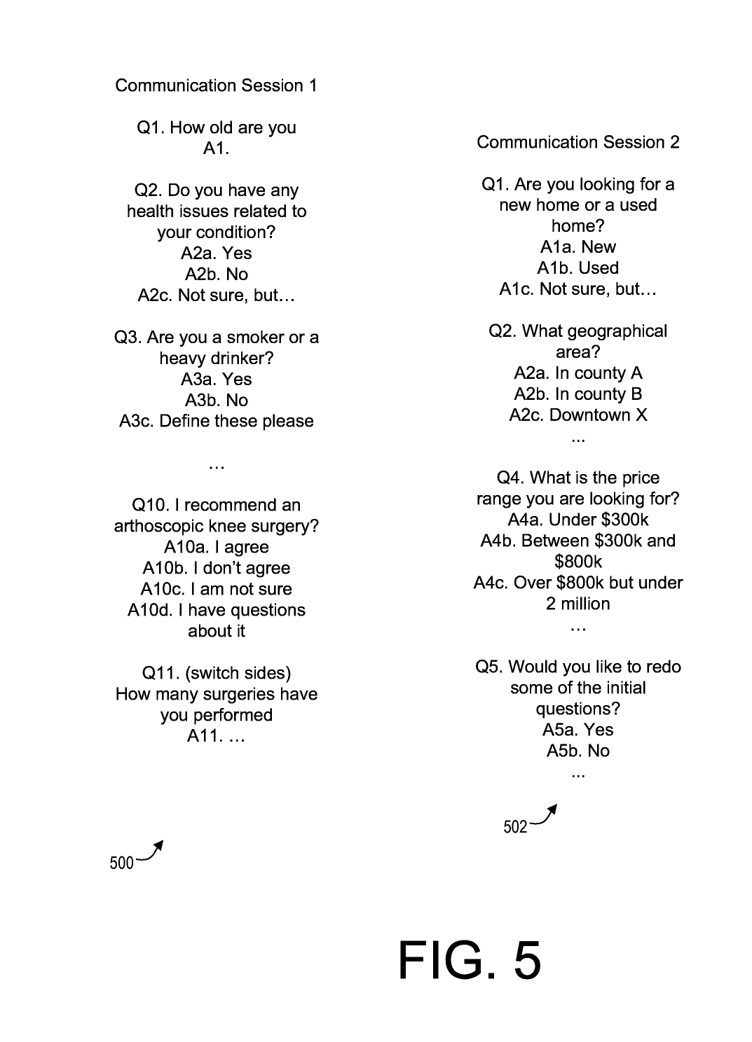

At element 312, the discussion server determines the next steps (example set of QA) to be provided to the computing devices. The logic determines the next steps based on the provided step and the received response. If the selected response is not one of the pre-determined responses, then the logic can determine a different step (e.g., from the set of Q&A 186 of FIG. 1C, or a knowledge base) than if the answer were one of the provided answers. In one case, the next question can be one of the questions that has already been provided. Some examples of the provided questions and answers are shown with reference to FIG. 5.

FIGS. 4A and 4B illustrate topics 400 and 450 of operation during a discussion session. FIG. 4A illustrates operation by a computing device, such as by the second computing device (e.g., of a patient) of FIG. 1A. FIG. 4B illustrates operation by a computing device, such as by the first computing device (e.g., of a doctor) of FIG. 1A. The methods of FIGS. 4A and 4B will be described in reference to elements of FIGS. 1A-1C. However, it is noted that the method is not limited to that implementation. Also, the method of topics 400 and 450 may be modified by those skilled in the art in order to derive alternative embodiment(s). Also, the steps may occur in a different order than shown, some steps may be performed concurrently, some steps may be combined with other steps, and/or some steps may be absent, as desired.

At element 402, the computing device accesses a discussion server. At element 404, the computing device selects a provider and/or a process. For example, a user of the computing device selects a knee operation procedure (topic) in the medical area. The computing device then communicates to the discussion server a selection of this process.

At element 406, the computing device receives a next question to be provided to the other computing device. For example, the computing device receives a question related to the age of the patient if the process is in the medical area. At element 408, the computing device provides a question to the other computing device. The provided question can be the question received from the discussion server. However, in one case, the provided question can be another question, such as a modified version of the received question or a new question. It is noted that if the provided question differs from the received question, the provided question is also communicated to the discussion server, such that the discussion server can update its logic and/or the next steps associated with this topic.

At 410, the computing device receives a selected answer from the other computing device. For example, the computing device can receive an answer indicating the age of the patient. It is noted that the selected answer is provided to both the computation device and to the discussion server. In case the computing device is a mobile phone, a tablet, or another type of a networked mobile device, the computing device can display the selected answer from the other computing device, e.g., for the user.

At 412, the computing device determines whether there are additional questions to be provided to the other computing devices. This determination can be based on input from the other computing device (e.g., indicating that the current discussion session should be terminated), based on local input received by the computing device (e.g., from a user of the computing device), or if there are no more steps associated with the current topic. If there are additional questions to be provided, elements 406-410 are performed again. Otherwise, element 414 can be performed. In element 414, the computing device can optionally provide a meeting rating to the discussion server.

Referring to FIG. 4B, at element 452, a computing device accesses a discussion server. At element 454, the computing device receives a notification of a provider and/or a topic. For example, a user (a doctor) of the computing device receives a notification that a patient would like to conduct a discussion session regarding a knee operation procedure (topic) in the medical area.

At element 456, the computing device receives next answers to be provided in response to a question from the other computing device. The computing device can also receive the question from the other computing device. In one case, a user of the other computing device can provide the question to a user of the computing device without using the computing device, e.g., verbally.

At element 458, the computing device determines a selected answer from the received answers or from the user input. In one case, the computing device receives an input indicating the selected answer. In another case, the computing device determines the selected answer automatically, e.g., based on a local logic. In some embodiments, the computing device displays a percentage of the most commonly used answers.

At element 460, the computing device provides the selected answer to the other computing device, and also to the discussion server.

At element 462, the computing device determines whether additional questions will be provided by the other computing device. This determination can be based on input from the other computing device (e.g., indicating that the current discussion session should be terminated), based on local input received by the computing device (e.g., from a user of the computing device), or if there are no more steps associated with the current topic. If there are additional questions to be provided, element 454 is performed again. Otherwise, element 464 can be performed. In element 464, the computing device can optionally provide a meeting rating to the discussion server.

FIG. 5 illustrates two example discussion sessions as facilitated by a discussion server. Discussion session 1 500 is related to a medical area. The first question (Q1) is provided by the discussion server to the first computing device (e.g., of the doctor), and a first set of possible answers are provided to the second computing device (e.g., of the patient). In this case, the question of “How old are you” is provided to the first computing device, and a set of possible ages (or ranges of ages) is provided to the second computing device. The first computing device can then provide Q1, or another question, to the second computing device. Upon receiving Q1, the second computing device provides an answer to the question Q1 received from the first computing device. The second computing device and/or the first computing device also provide the actual first question and answer used during the discussion session to the discussion server. Here, the discussion server then determines the next question based on the age of the patient.

The next question Q2 is then provided to the first computing device and associated answers A2a-A2c are provided to the second computing device. Once the first computing device provides Q2 to the second computing device, the second computing device can respond with one of the suggested answers A2a-A2c. In case of Q3 being provided, each of the answers A3a, A3b, and A3c could necessitate a different Q4. For example, upon the second computing device choosing answer A3c, the discussion server would provide an explanation of the terms used by Q3, and then possibly provide Q3 again to the first computing device such that Q3 is asked again.

Question Q10 illustrates an example of a possible conclusion of the discussion session. At the time Q10 is sent to the first computing device, a procedure is recommended by the first computing device to the second computing device. For example, based on the previous questions and answers, and optionally on additional information about the patient, the doctor can recommend a procedure of an arthroscopic knee surgery to the patient. In one implementation, the discussion server can (i.e., as determined by using logic associated with the current process) send multiple procedure recommendations (e.g., different types of knee surgery) to the first computing device. The doctor would then select one of these procedures. In one implementation, the discussion server can send percentages indicating how often other doctors that use this process (and/or related processes) choose each procedure. For example, the discussion server can indicate that over 50% of other doctors select arthroscopic knee surgery and only 10% of doctors select another type of knee surgery. These percentages can be determined by the discussion server based on multiple discussion sessions related to the same (and/or similar) process.

Q11 illustrates an example of switching sides between the first and the second computing devices. In one case, the discussion server determines to switch sides upon receiving an answer from the second computing device indicating that the second computing device may be used to provide questions to the first computing device. As shown by answer A10d, the second computing device may be used to provide questions about Q10 to the first computing device. Thus, Q11 is provided by the discussion server to the second computing device, and possible answers associated with Q11 are provided to the first computing device. It is noted that the sides may switch again, i.e., such that the second computing device provides another procedure recommendation to the first computing device.

A discussion session 2 502 is related to a real estate area. The first question (Q1) is provided by the discussion server to the first computing device (e.g., of a real estate broker), and a first set of possible answers are provided to the second computing device (e.g., of a client). In this case, the question of “Are you looking for a new home or a used home” is provided to the first computing device, and possible answers A1a-A1c are provided to the second computing device. The next questions Q2-Q5 and associated answers are provided to the computing devices. Q5 illustrates an example of providing a previous question again. In this case, question Q5 is provided by the discussion server to the first computing device, and a first set of possible answers are provided to the second computing device. The second computing device can indicate, i.e., by selecting answer A5a, that one or more of the previous questions should be redone.

FIGS. 6A and 6B illustrate one implementation of a portion of logic that can be used with a process. This logic example uses a decision tree 650, although other implementations are contemplated. In FIG. 6A, a first question Q1 602 can correspond to a first question provided to a computing device. Question Q1 (as the other questions Q2-Q8) is associated with answers (not shown) that are provided to the other computing device during a discussion session. Depending on the answer received from the other computing device, the logic can select Q2 604 or Q3 606. If Q2 604 is selected, then the subsequent questions would be Q4 608 or Q5 610. Similar process is shown with relation to questions Q3 606, Q6 612, Q7 614, and Q8 616. It is noted that additional questions can be used. FIG. 6B illustrates how the portion of the logic of FIG. 6A is modified. A decision tree 652 illustrates how the dependencies of questions Q1-Q8 652-666 are modified, such as based on the ratings for the process. As FIG. 6B illustrates, the dependencies of questions Q6, Q7, and Q8 are modified. In addition, question Q3 (of FIG. 6A) is replaced with question Q9 656.

### Example Computer System Implementations

The embodiments described herein, including systems, methods/processes, and/or apparatuses, may be implemented using well known servers/computers. For example, discussion device 104 and computing devices 102 of FIG. 1A and the methods described in the flowcharts depicted in FIGS. 2-4 can be implemented using one or more computers 700.

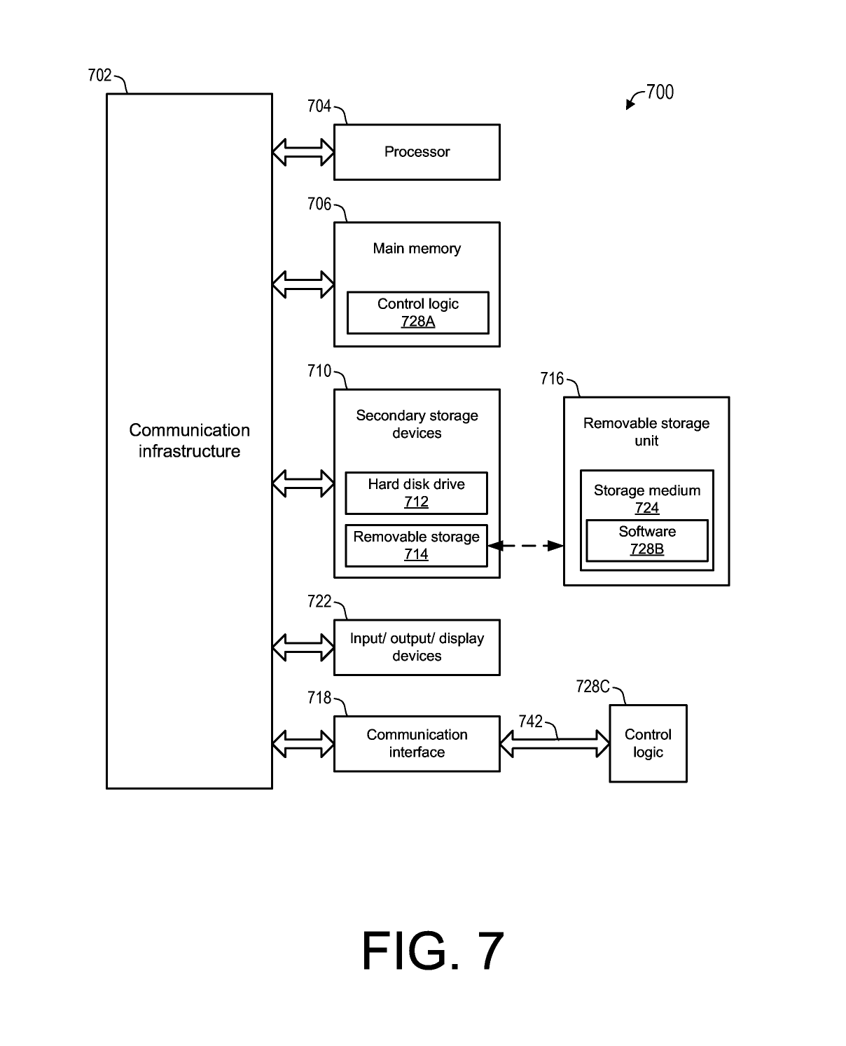

FIG. 7 depicts a block diagram of an example computer system in which embodiments of the present invention may be implemented. Computer 700 can be any commercially available and well known computer capable of performing the functions described herein, such as computers available from APPLE, LENOVO, HP, DELL, ASUS, SAMSUNG, SONY, etc. Computer 700 may be any type of computer, including a desktop computer, a server, a laptop computer, a mobile device, a smart device, a tablet, etc.

Computer 700 includes one or more processors (also called central processing units, or CPUs), such as a processor 704. Processor 704 is connected to a discussion infrastructure 702, such as a discussion bus. In some embodiments, processor 704 can simultaneously operate multiple computing threads.

Computer 700 also includes a primary or main memory 706, such as random access memory (RAM). Main memory 706 has stored therein control logic 728A (computer software), and data.

Computer 700 also includes one or more secondary storage devices 710. Secondary storage devices 710 include, for example, a hard disk drive 712 and/or a removable storage device or drive 714, as well as other types of storage devices, such as memory cards and memory sticks. For instance, computer 700 may include an industry standard interface, such a universal serial bus (USB) interface for interfacing with devices such as a memory stick. Removable storage drive 714 represents a floppy disk drive, a magnetic tape drive, a compact disk drive, an optical storage device, tape backup, etc.

Removable storage drive 714 interacts with a removable storage unit 716. Removable storage unit 716 includes a computer useable or readable storage medium 724 having stored therein computer software 728B (control logic) and/or data. Removable storage unit 716 represents a floppy disk, magnetic tape, compact disk, DVD, optical storage disk, or any other computer data storage device. Removable storage drive 714 reads from and/or writes to removable storage unit 716 in a well known manner.

Computer 700 also includes input/output/display devices 722, such as monitors, keyboards, pointing devices, etc.

Computer 700 further includes a discussion or network interface 718. Discussion interface 718 enables computer 700 to communicate with remote systems and devices. For example, discussion interface 718 allows computer 700 to communicate over discussion networks or mediums 772, such as LANs, WANs, the Internet, etc. Network interface 718 may interface with remote sites or networks via wired or wireless connections.

Control logic 728C may be transmitted to and from computer 700 via the discussion medium 772. More particularly, computer 700 may receive and transmit carrier waves (electromagnetic signals) modulated with control logic 728C via discussion medium 872.

Any apparatus or manufacture comprising a computer useable or readable medium having control logic (software) stored therein is referred to herein as a computer program product or program storage device. This includes, but is not limited to, computer 700, main memory 706, secondary storage devices 710, and removable storage unit 716. Such computer program products, having control logic stored therein that, when executed by one or more data processing devices, cause such data processing devices to operate as described herein, represent embodiments of the invention.

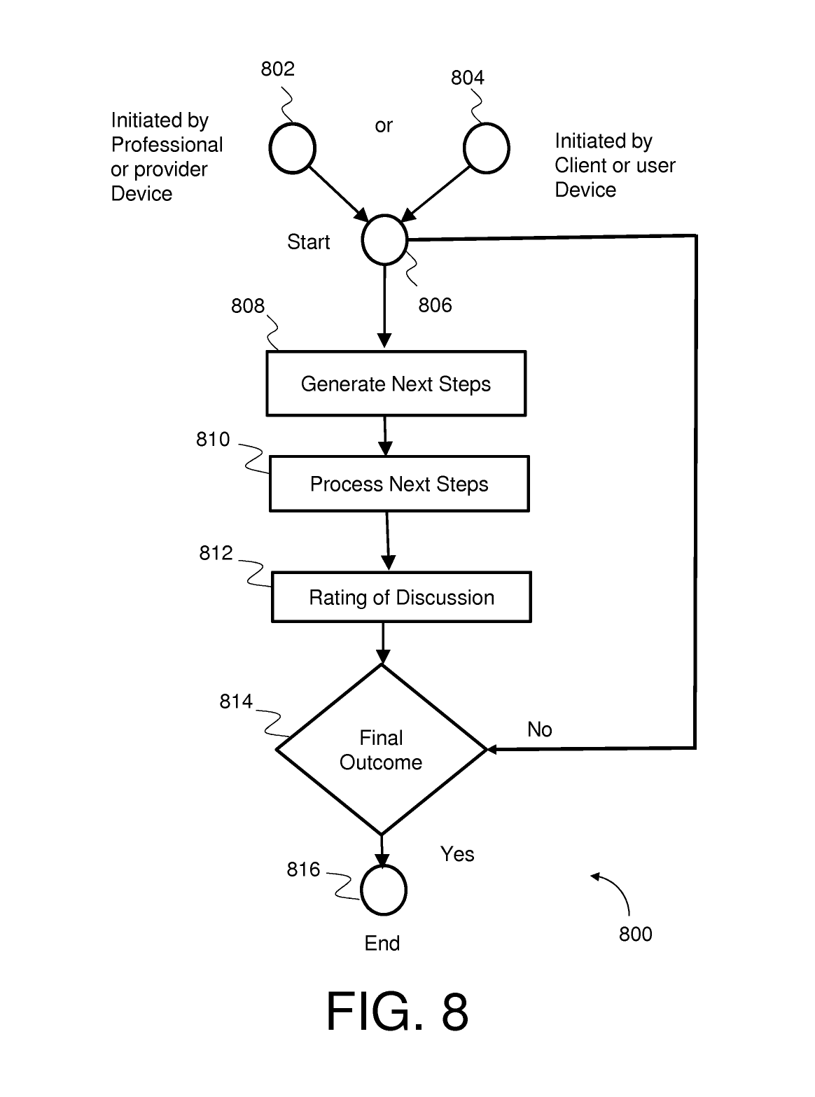

In other disclosed embodiments, FIG. 8 depicts a flowchart 800 of a method for facilitating a discussion session between two computing devices, according to some embodiments. FIG. 8 may provide an alternate embodiment to the embodiments disclosed above. Professional device 802 may be engaged by the consultant, or professional/provider, and used to initiate a discussion session 806. Client device 804 may be engaged by a client or user to also initiate a discussion session 806. Discussion session 806 may represent a meeting or communication session between the consultant and the client.

At element 808, the next steps are generated based on the discussion session 806. This element is disclosed in greater detail below. At element 810, the next steps are processed. This processing action may include recording or tabulating the questions and responses during discussion session 806. At element 812, the discussion session is rated. The consultant or the client may provide immediate feedback about whether the discussion session, including the questions and responses (the steps taken during the discussion), were beneficial. At element 814, a final outcome is determined whether to return back to the discussion session, and, in turn, element 808. Otherwise, element 816 executes by ending the discussion session.

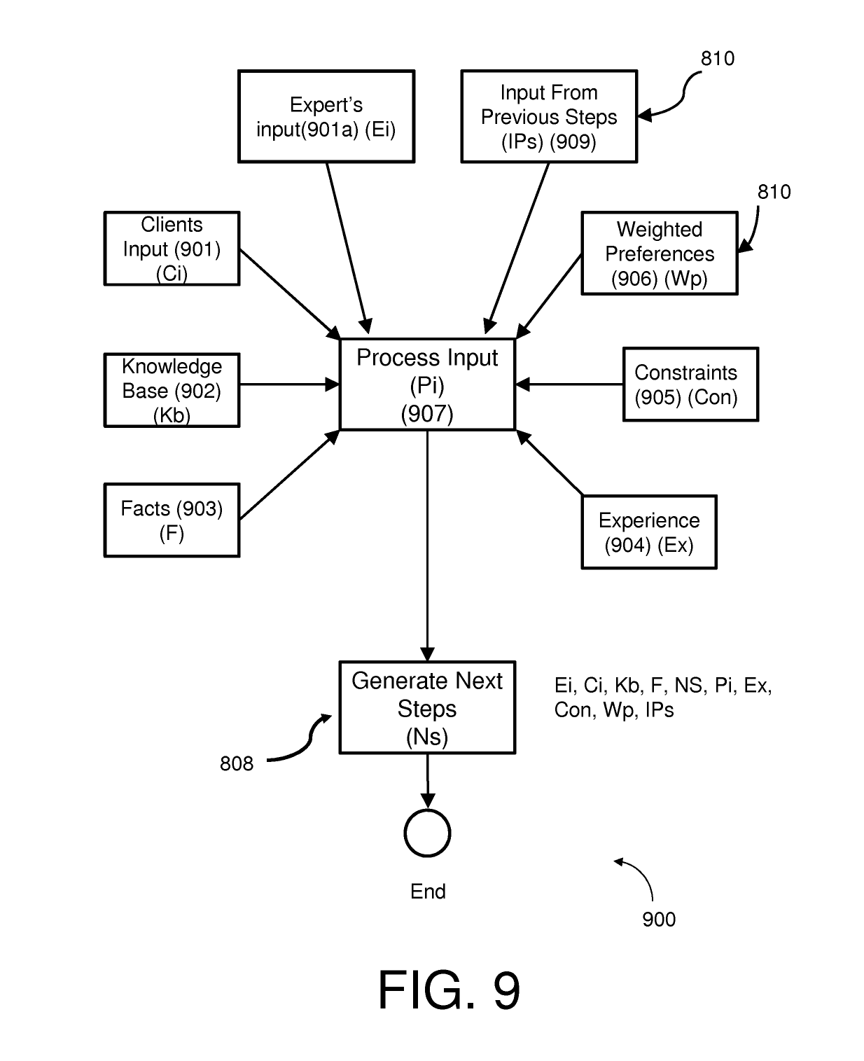

FIG. 9 depicts a flowchart 900 for generating the next steps in a discussion session, according to some embodiments. Some example next steps include activities, checklists, questions, discovery of unknowns, read information, sign consent or other forms, any actionable item and the like. The generation of the next steps may involve taking into account a plurality of data points and the following disclosed process shown in FIG. 9. The disclosed process may be a self-learning process that analyzes data from all inputs to generate the next steps. These next steps are presented to the consultant/professional and the client.

The inputs may come from a variety of sources. The sources provide information, such as information seeded into the system, information captured from exports, information captured from clients, and information derived from the processing the steps.

Referring to FIG. 9, expert's input 901a (shown as Ei) denotes the information provided by the consultant/professional. This input may come from the expert based on knowledge or experience. Client's input 901 (shown as Ci) may include information from the client, including budget constraints, the client's condition, risk profile, personal information and the like.

Knowledge base 902 (shown as Kb) may refer to market history, physical laws, credit availability, probabilities, and the like. Facts 903 (shown as F) may refer to specific known bits of information available from verified sources. These may include online textbooks, academic resources, and the like. Experience 904 (shown as Ex) may refer to previous interactions between the consultant/professional and the client. Structured outcome captured from previous steps may be available as input/filter/selection criteria that is applied on knowledge base 902 in generating the next steps.

Constraints 905 (shown as Con) may refer to any limits placed on the steps available for performing element 808. For example, budgetary or time constraints. Steps that fall outside the constraints, such as being too expensive or not quick enough, will not be considered for the next steps. Weighted preferences 906 (shown as Wp) may refer to weights signifying preferences set forth by the client or consultant/professional. For example, a client may prefer to avoid surgery if possible for a medical procedure. The consultant may prefer to use the laws of a certain state in giving advice. Weights may be from 1-20, or relative weights. Weighted preferences 906 may be established by the processing element 810 of FIG. 8. Input 909 from previous steps (shown as IPs) also may refer to any information compiled from previous iterations during the discussion session. Input 909 may include responses to previous questions.

At element 907, all these inputs are processed to generate the next steps. Element 907 may implement the following algorithm in generating the next steps. Element 907 may compile expert input 901a, client input 901, weighted preferences 906 and experience 904 into a set referred to as the Users Input (Ui), and shown as Ei U Ci U Wp U Ex. Another set of data is compiled for facts 903, constraints 905 and input 909 from previous steps. This set of data may be referred to as All Constraints (AC) and shown as F U Con U IPs. Element 907 then filters the Users Input by the All Constraints as well as knowledge base 902 to generate Next Steps (NS). This relationship may be shown as Kb∩Ui∩AC=Ns. Thus, using these inputs and filtering them accordingly, the generated next steps may narrow down from broad questions to better serve the client and increase the applicability of the consultant's services. In other words, time is not wasted on steps that do not pertain or are not available to the topic of discussion.

According to the disclosed embodiments, the initial questions and answers, or steps, may refer to top level questions that start a conversation or discussion session. The disclosed process to generate the next steps, such as subsequent questions and answers, may be one that uses a knowledge base to select the next steps. A checklist may refer to a list of items required, things to be done, or points to be considered, or items used as a reminder.

The knowledge base may refer to a list of questions that have been created with inter-dependencies and pre-requisites from best practices. These may be those items known through experience or industry norms. An experience base may refer to a list of questions from prior design logic.

The invention can work with software, hardware, and/or operating system implementations other than those described herein. Any software, hardware, and operating system implementations suitable for performing the functions described herein can be used.

While various embodiments of the present invention have been described above, it should be understood that they have been presented by way of example only, and not limitation. It will be apparent to persons skilled in the relevant art(s) that various changes in form and details may be made to the embodiments described above without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
acquiring a first checklist from a first provider, wherein the first checklist is associated with a first process;
determining a first set of questions and answers from the first checklist, wherein each question is associated with one or more respective answers;
acquiring a second checklist from the first provider, wherein the second checklist is associated with the first process;
selecting a process associated with the first checklist based, at least in part, on a first selection from a first device;
providing a first question of the first set to the first device;
providing first one or more answers of the first set to a second device, wherein the first one or more answers are associated with the first question;
receiving a selected first answer from the second device, wherein the selected first answer is associated with the first question;
determining a second question from the first set and associated second one or more answers based, at least in part, on the first question and the selected first answer.

2. The method of claim 1, further comprising:
determining logic from the first checklist based, at least in part, on an order of questions and associated answers for the first checklist, wherein
the logic indicates one or more of,
a sequence of questions and associated answers, and
at least one condition for selecting a next question and associated one or more answers.

3. The method of claim 1, further comprising:
providing the second question to the first device;
providing the second one or more answers to the second device;
receiving an indication of a third question used by the first device during a discussion session between the first device and the second device,
in response to determining that that the second question is different from the third question, modifying the first checklist using the third question and an associated third answer.

4. The method of claim 1, further comprising:
providing first ratings for each of the first one or more answers to the second device, wherein the first ratings indicate use percentages of one or more of:
the one or more answers associated with the second process, and
a majority of other second devices that use the first process.

5. The method of claim 1, further comprising:
determining a session rating of a discussion session between the first device and the second device, wherein
the first checklist is used during the discussion session for providing the first set of questions and answers,
the determining the rating is based, at least in part, on discussion session parameters, wherein the discussion session parameters comprise one or more of,
a length of the discussion session,
a number of questions and answers from the first set of questions and answers used during the discussion session, and
a respective ratings of each of the used questions and answers.

6. The method of claim 5, wherein said determining the session rating comprises:
assigning weights for each of the discussion session parameters, and
adjusting the weights of the discussion session parameters based on user feedback.

7. The method of claim 1, further comprising:
adjusting the first set of questions and answers based on the selected first answer, wherein the adjusted first set of questions and answers includes at least one question and associated one or more answers that are not available in the first set of questions and answers.

8. The method of claim 1, further comprising:
providing the second question to the first device;
providing the second one or more answers to the second device;
receiving a selected second answer from the second device, wherein the selected second answer is associated with the second question; and
in response to receiving the selected second answer, determining whether to provide, again, the first question to the first device and the first answer to the second device.

9. The method of claim 2, further comprising:
adjusting the logic based on the second checklist, and
adjusting the logic based on a session rating between the first device and the second device.

10. A system comprising:
a processor;
a network interface coupled to the processor; and
a memory coupled to the processor, the memory storing instructions that when executed by the processor, cause the system to:
acquire a first checklist from a first provider, wherein the first checklist is associated with a first process;
determine a first set of questions and answers from the first checklist, wherein each question is associated with one or more respective answers;
acquire a second checklist from the first provider, wherein the second checklist is associated with the first process;
select a process associated with the first checklist based, at least in part, on a first selection from a first device;
provide a first question of the first set to the first device;
provide first one or more answers of the first set to a second device, wherein the first one or more answers are associated with the first question;
receive a selected first answer from the second device, wherein the selected first answer is associated with the first question; and
determine a second question from the first set and associated second one or more answers based, at least in part, on the first question and the selected first answer.

11. The system of claim 10, wherein the instructions further cause the system to:
determine logic from the first checklist based, at least in part, on an order of questions and associated answers for the first checklist, wherein
the logic indicates one or more of,
a sequence of questions and associated answers, and
at least one condition for selecting a next question and associated one or more answers.

12. The system of claim 10, wherein the instructions further cause the system to:
provide the second question to the first device;
provide the second one or more answers to the second device;
receive an indication of a third question used by the first user during a discussion session between the first device and the second device; and
in response to determining that that the second question is different from the third question, modify the first checklist using the third question and an associated third answer.

13. The system of claim 10, wherein the instructions further cause the system to:
provide first ratings for each of the first one or more answers to the second device, wherein the first ratings indicate use percentages of one or more of:
the one or more answers associated with the second process, and
a majority of other second users that use the first process.

14. The system of claim 10, wherein the instructions further cause the system to:
determine a session rating of a discussion session between the first device and the second device, wherein
the first checklist is used during the discussion session for providing the first set of questions and answers,
the determining the rating is based, at least in part, on discussion session parameters, wherein the discussion session parameters comprise one or more of,
length of the discussion session,
a number of questions and answers from the first set of questions and answers used during the discussion session, and
a respective ratings of each of the used questions and answers.

15. A non-transitory machine-readable medium, having instructions stored therein, which when executed by a processor cause the processor to:
acquire a first checklist from a first provider, wherein the first checklist is associated with a first process;
determine a first set of questions and answers from the first checklist, wherein each question is associated with one or more respective answers;
acquire a second checklist from the first provider, wherein the second checklist is associated with the first process;
select a process associated with the first checklist based, at least in part, on a first selection from a first device;
provide a first question of the first set to the first device;
provide first one or more answers of the first set to a second device, wherein
the first one or more answers are associated with the first question;
receive a selected first answer from the second device, wherein the selected first answer is associated with the first question; and
determine a second question from the first set and associated second one or more answers based, at least in part, on the first question and the selected first answer.

16. The non-transitory machine-readable medium of claim 15, wherein the instructions when executed further cause the processor to,
determine logic from the first checklist based, at least in part, on an order of questions and associated answers for the first checklist, wherein
the logic indicates one or more of,
a sequence of questions and associated answers, and
at least one condition for selecting a next question and associated one or more answers.

17. The non-transitory machine-readable medium of claim 15, wherein the instructions when executed further cause the processor to,
provide the second question to the first device;
provide the second one or more answers to the second device;
receive an indication of a third question used by the first device during a discussion session between the first device and the second device; and
in response to determining that that the second question is different from the third question, modify the first checklist using the third question and an associated third answer.

18. The non-transitory machine-readable medium of claim 15, wherein the instructions when executed further cause the processor to,
provide first ratings for each of the first one or more answers to the second device, wherein the first ratings indicate use percentages of one or more of:
the one or more answers associated with the second process, and
a majority of other second users that use the first process.

19. The non-transitory machine-readable medium of claim 15, wherein the instructions when executed further cause the processor to,
determine a session rating of a discussion session between the first device and the second device, wherein
the first checklist is used during the discussion session for providing the first set of questions and answers,
the determining the rating is based, at least in part, on discussion session parameters, wherein the discussion session parameters comprise one or more of,
length of the discussion session,
a number of questions and answers from the first set of questions and answers used during the discussion session, and
a respective ratings of each of the used questions and answers.

20. The non-transitory machine-readable medium of claim 16, wherein the instructions when executed further cause the processor to,
adjusting the logic based on the second checklist, and
adjusting the logic based on a session rating between the first device and the second device.
